(19) United States
(12) Patent Application Publication
(10) Pub. No.: US 2007/0124869 A1
(43) Pub. Date: Jun. 7, 2007

(54) Product of fibrous material providing a fresh feeling for skin by contact therewith

(75) Inventors: Bruno Bret, Wintzenheim (FR); Sebastien Jeannot, Bischwihr (FR)

Correspondence Address: PATENT GROUP GA030-43;GEORGIA-PACIFIC LLC, 133 PEACHTREE STREET, N.E., ATLANTA, GA, 30303-1847, US

(73) Assignee: Georgia-Pacific France, Kunheim (FR)

(21) Appl. No.: 10/595,745

(22) PCT Filed: Nov. 9, 2004
(86) PCT No.: PCT/FR04/02877

§ 371 Date: May 9, 2006

(30) Foreign Application Priority Data
Nov. 14, 2003 (FR) 03 13344

(51) Int. Cl. C11D 3/00

(52) U.S. Cl. 8/115.51

(57) ABSTRACT

The invention relates to a product of fibrous materials imparting a sense of freshness on coming in contact with the skin. It is characterized in that it includes, at least in part on the surface, 0.1 g/m² to 20 g/m² of an agent including a fatty acid ester or mixture of such esters the carbon chain of which is C10-C14 and of alcohol the carbon chain of which is C10-C14. In particular, the agent can melt at a temperature of 20° C. to 37° C. and includes at least 60% of such ester or esters, the remainder being selected from among solvents, fatty acid esters, fatty alcohols, or mineral oils. Specifically, the agent includes at least the dodecylic ester of dodecanoic acid.

This invention relates to the area of fibrous materials, cellulose materials in particular, which are brought into contact with the skin when used, such as absorbent kinds of paper or cloth or nonwoven products. In the case of absorbent types of paper, it relates in particular to products such as toilet paper, handkerchiefs, napkins, makeup removal napkins, chiffon paper, dry cleaning cloths, or hand towels. In the case of cloth or nonwoven products, the fibers are natural, in particular ones of cotton, and artificial or synthetic fibers. The invention also relates to water absorbent cotton as a cloth and to nonwoven cotton.

It relates in particular to products to which an agent is applied the function of which is to impart a refreshing effect, a sensation of freshness, when users bring the products into contact with their skin.

Absorbent paper is understood in this technical field to mean tissue paper which is obtained either by the wet method, or to mean tissue paper that is obtained by the dry method, and made up of paper fibers bound by a bonding agent, such as latex.

Since the skin is rubbed with these products during use, manufacturers regularly try to improve the quality of contact and comfort of use by affecting the method of manufacture of the sheet, the fibers which make up the sheet, or the state of the surface.

In the case of paper, for example, one means consists of applying a more or less large amount of lotion to the surface. The lotion improves the qualities of softness, smoothness, and flexibility to the touch. It prevents the products from being irritating to the skin. This quality is sought for disposable handkerchiefs, for example. Application of a suitable lotion to the paper reduces the irritation caused by the rubbing of the handkerchief against the nose.

The applicant has developed lotions exerting an emollient effect on the skin, such as the lotion described in EP Patent 882155.

Application of a lotion or fragrance to the paper imparting a refreshing effect for the user has also been disclosed. For example, the applicant markets handkerchiefs scented with menthol which possess this property.

However, the menthol may not be accepted by the user because its fragrance is strong. The applicant has set for itself the objective of developing a new lotion-impregnated fibrous product whose contact with the skin produces in the user a sensation of freshness without this sensation being associated with a particular odor.

It is claimed for the invention that the product, of a fibrous material imparting a sensation of freshness when it is brought into contact with the skin, is characterized by the fact that it comprises, at least partly on the surface, 0.1 to 20 g per m² of an agent comprising a fatty acid ester or a mixture of fatty acid esters the carbon chain of which is of C10-C14 and of alcohol the carbon chain of which is of C10-C14. In particular, the melting point of the agent ranges from 20 to 37° C.

The agent optionally includes another compound, such as one selected from among solvents, fatty acid esters, fatty alcohols, or mineral oils. However, it includes at least 60% of such ester.

It is advantageous for the agent to comprise the dodecyl ester of dodecanoic acid or lauryl laurate.

Lauryl laurate is a fatty acid ester with the formula CH₃(CH₂)₁₀COO(CH₂)₁₁CH₃ and may be produced from lauryl alcohol and methyl laurate. A product comprising 75% of this compound is marketed by the Strahl & Pitsch company under the name PURESTER, in particular the name PURESTER 24. It has the particular feature of having a melting point of about 25° C.

This product is known in the sphere of cosmetic products and is part of the composition of creams or lotions, of lipsticks for example, lotions for protection from sunlight, bath oils, or shampoos.

The agent preferably contains 75% to 40, 45% lauryl laurate when it is prepared with PURESTER 24.

Surprisingly it has been found that a sensation of coolness to the touch is obtained by applying a sufficiently small amount of this agent to a fibrous material, such as a sheet of absorbent paper, that is, on the average and at least partly on the surface, an amount of 0.1 g/m² to 20 g/m². Preferably, the product comprises at least 2 g/m² of the product on the average and in practice comprises at least 6 g/m². The greater part of it preferably is on the surface; a small proportion may be absorbed by the substrate.

The agent may be applied on the surface continuously, but preferably is applied discontinuously so as to have larger amounts locally, for example, in parallel strips or in the form of slabs, uniformly distributed or not, over the surface.

A description is given in what follows of several modes of application of the agent to a sheet of tissue paper, with reference to the drawings in which

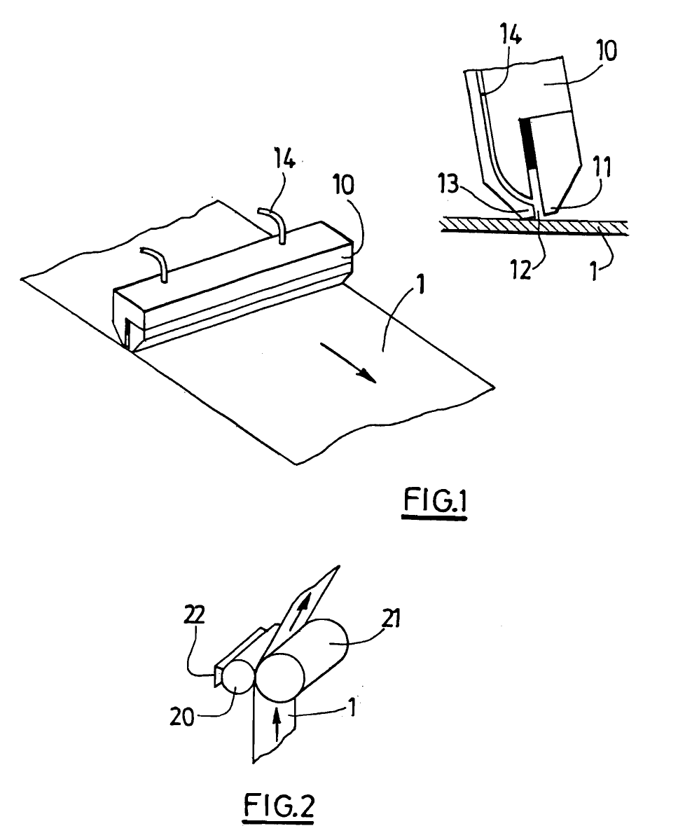

FIG. 1 shows in two illustrations a first mode of application by depositing by means of a tank provided with a lip nozzle,

FIG. 2 shows a second mode of application by roller.

The application illustrated in FIG. 1 represents extrusion onto a sheet in movement.

The treatment may be applied in the process of conversion of a sheet coming from a jumbo reel. In the case of absorbent paper, for example, the conversion of such paper to toilet paper comprises a stage of embossing in an installation for embossing and assembly, if applicable, of several plies one on the other to form a multi-ply sheet. The sheet thus converted is then guided to a station for winding and cutting to form individual rolls.

In this application, the treatment claimed for the invention preferably is performed over the length of the sheet between the embossing stage and the winding and cutting stage. However, the treatment may be applied just as well to a sheet before it is embossed.

The sheet 1 is moved to an agent application station. This station comprises a tank 10 positioned transversely to the direction of movement of the sheet to be treated. The bottom of the tank is open along a slot 12 with two parallel edges 11 and 13 forming a lip nozzle. The width of the slot 12 and the distance between the lips determine the discharge of liquid which is deposited on the sheet for a given pressure and fluid state. A plurality of slots may be made across the machine width rather than a single slot. Each slot determines the width of a strip of product deposited on the sheet of paper.

Selection of slots of appropriate width ensures that the product will be deposited either on a continuous surface across the machine width or on separate surface areas in the form of strips. The agent may also be deposited on portions of successive strips through periodic interruption of the supply 14 from the tank 10 which delivers the agent in the fluid state to the lip nozzle or nozzles.

The tank 10 includes heating means making it possible to keep the agent at a temperature selected. In the case of an agent consisting of at least 75% lauryl laurate, the melting point of which is 25° C., the temperature in the tank is kept at at least 25° C., in any event not exceeding a temperature at which the fluidity would be such that the paper would be excessively impregnated. The agent preferably is applied to the surface of the paper.

Testing of application of the agent to tissue paper was conducted by means of lip nozzle equipment supplied by the Nordson company. The equipment was positioned in a conversion installation between the embossing unit and the roll winding station.

Several application nozzle widths were tested. Use was made of nozzles having apertures respectively of 11 mm, 22 mm, and 70 mm spaced respectively at intervals of 22 mm, 22 mm, and 40 mm, and of a nozzle extending over the entire machine width.

The temperature of the agent, PURESTER 24®, was kept between 37° C. and 50° C. at the time of its application to the sheet. The rate of application ranged from 0.1 to 10 g/m² per strip.

The product samples were submitted to a panel of users. A refreshing effect was found to a significant extent starting with an average amount of 2 g/m² applied. It was deemed satisfactory starting at 3 g/m².

Other modes of application are possible.

The technique of coating by roller, as illustrated in FIG. 2, includes of causing a sheet 1 of fibrous product to pass between an applicator roller 20 and a mating roller 21. The applicator roller comprises cavities containing the agent in the liquid state and fed by a doctor blade box 22. The entire unit is kept at a temperature sufficient to keep the agent in the fluid state while being deposited on the sheet as it moves over the space made between the two rollers 20 and 21. The depositing in metered amounts may be continued or discontinued as a function of engraving of the applicator roller.

In an alternative embodiment (not shown), the agent is applied by means of a transfer cylinder between the cylinder having the cavities and the mating roller.

In another method (not shown), the agent is applied by atomization, for example, by the method described in EP Patent 1108814 filed in the name of the applicant.

1-14. (canceled)

15. A product of fibrous material imparting a sense of freshness when said product contacts skin, comprising at least in part on a surface of said product 0.1 g/m² to 20 g/m² of an agent comprising at least one fatty acid ester wherein a carbon chain of which is of C10-C14 and of alcohol a carbon chain of which is of C10-C14.

16. A product of fibrous material according to claim 15, wherein the agent melts at a temperature in a range from 20° C. to 37° C.

17. A product of fibrous material according to claim 15, wherein the agent comprises at least 60% of said at least one ester, with a remainder being selected from solvents, fatty acid esters, fatty alcohols, or mineral oils.

18. A product of fibrous material according to claim 15, wherein the agent comprises at least dodecylic ester of dodecanoic acid.

19. A product of fibrous material according to claim 15, wherein the agent comprises between 75% and 40% by weight of dodecylic ester of dodecanoic acid.

20. A product of fibrous material according to claim 15, wherein the agent is distributed substantially on the surface of the product.

21. A product of fibrous material according to claim 15, wherein said product comprises at least 2 g/m² of said agent.

22. A product of fibrous material according to claim 21, wherein said agent is less than 6 g/m².

23. A product of fibrous material according to claim 15, wherein the agent is distributed discontinuously over said product.

24. A product of fibrous material according to claim 23, wherein the agent is distributed in strips parallel to each other over said product.

25. A product of fibrous material according to claim 15, wherein the agent is distributed as a continuous film over said product.

26. A product of fibrous material according to claim 15, wherein the agent is distributed over a top surface and a bottom surface of said product.

27. A product of fibrous material according to claim 15, wherein the fibrous material comprises an absorbent paper.

28. A product of fibrous material according to claim 15, wherein the fibrous material comprises absorbent cotton or a bonded web of natural, artificial or synthetic textile fibers.

29. A product of fibrous material according to claim 15, wherein the fibrous material is of cotton or cotton in mixture with artificial or synthetic fibers.
